(19) United States
(12) Patent Application Publication
(10) Pub. No.: US 2008/0051922 A1
(43) Pub. Date: Feb. 28, 2008

(54) Intelligent 3D fixture design method

(76) Inventors: Bor-Tsuen Lin, Yangmei Township (TW); Tung-Kuan Liu, Linyuan Township (TW); Chia-Nung Tsai, Ciaotou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,553

(22) Filed: Aug. 22, 2006

(51) Int. Cl. G06F 19/00

(52) U.S. Cl. 700/98; 706/919

(57) ABSTRACT

An intelligent 3D fixture design method, which can solve interference problems between each workpiece, tool and fixture module to design optimal types, specifications and layouts of the fixture system. The design method of the present invention is based on a parametric solid model of 3D CAD software, which uses a space vector to determine if interference exists, and the interference position of such, between the solid models of workpieces, tools and fixture modules, and further utilizes a genetic algorithm to search type and its design shape and position parameters of each fixture modules, to design an optimal fixture system and related specification and layout.

### BACKGROUND OF THE INVENTION

1. Field of the Invention

The present invention relates to an Intelligent 3D Fixture Design method, which can be applied in industries that have fixture design optimization requirements, such as in: fixture system design industries, various mechanical process industries, various mechanical assembly industries, etc. The above-mentioned requirements include avoiding interference between fixture modules, avoiding movement interference between workpieces and fixture modules, and/or avoiding interference between tools and fixture modules during operation while satisfying fixing position and/or fixing force requirements, thereby obtaining an optimal (inexpensive) fixture system and related specification and layout. The intelligent 3D fixture design of the present invention solves these above-mentioned problems.

2. Description of the Related Art

With improvements in computer-related technologies, more and more industries rely on automated and intelligent computer technologies. Currently, fixture system designs utilize computer-aided design (CAD) software, which has parametric standard parts and/or fixture modules drawing files, however, this CAD software suffers from the following problems:
It is not easy to determine during the design stage whether there will be interference between fixture modules, interference in the movement between a workpiece and a fixture module, or interference between a tool and a fixture module.
The designing process may involve too many parameters related to select the type of fixture module and design its specification and layout, which are difficult to optimize.

Many studies are related to fixture system designs. Darvish and Gill built a knowledge representation database, which includes machine tool data, workpiece data and standard fixture data into the database to develop a fixture design system for machine tools. Miller and Hannam built a knowledge database for specific fixture designs and developed an interactive CAD/CAM, wherein an inexperienced user could use the data stored in the knowledge database to design a suitable fixture. Grippo et al. use CAD/CAM as a tool to automatically design and assemble a modularized fixture, and then adds a robot arm to achieve complete automation of the fixture system. Boerma and Kals developed a fixture design with automated workpiece positioning to incorporate the entire process planning system of workpieces into the fixture design process. Nee points out that fixture designs can be variant fixture designs and generative fixture designs; in variant fixture designs, since the workpieces are similar, the designer can utilize similar existing fixture formats to design a new fixture; generative fixture designs are used when there are no similar fixture designs. Nee and Kumer utilize a rule-base to develop fixture design expert systems that include workpiece data, process data, machine tool data, cutting tool data and fixture component data as input modules, and provides as an output result a fixture stacked with fixture components. Dong et al. utilize a feature-base to describe the workpiece during manufacturing process to select a best positioning point. Liu utilizes conjugate forms to design a search method of stackable components, and then obtains a new module by disassembly and assembly.

However, the above-mentioned studies focus on fixture designs for machine tools, which are inadequate for dealing with complicated shapes workpieces, fixtures and tools, or simultaneously providing decisions for types, specifications and layouts of fixtures. These involve in resolving a large numbers of parameters and include the inability to determine whether, and at what position, interference exists, extreme difficulty in obtaining optimal designs, long design times, and poor universality.

Therefore, it is desirable to provide an intelligent 3D fixture design method that mitigates and/or obviates the aforementioned problems.

### SUMMARY OF THE INVENTION

A primary objective of the present invention is to provide an intelligent 3D fixture design method, which can solve interference problems between each workpiece, tool and fixture module, and which optimizes types, specifications and layouts of fixture modules over large numbers of design parameters. As shown in FIG. 9, the present invention can check interference between fixture modules, movement interference between workpieces and fixture modules, and/or interference between tools and fixture modules during operation, while satisfying fixing position and/or fixing force requirements of the fixture module, thereby obtaining an optimal (and inexpensive) type and related specification and layout of fixture system.

The design method of the present invention is based on a parametric solid model of 3D CAD software, which uses a space vector to determine if interference exists, and the interference position of such, between each solid model of the workpiece, tool and fixture module, and further utilizes a genetic algorithm system to search type of each fixture module and its design shape and position parameters, to design an optimal fixture system and related specification and layout.

The method of the present invention combines the benefits of 3D CAD software, genetic algorithms and special interference algorithm to achieve an optimal design for 3D fixture system. Furthermore, the method consistently obtains stable results, particularly with certain types of complicated workpieces; for example, with medium to large sized complicated car body panel fixture system, the method of the present invention provides a superior performance over conventional fixture design methods. The algorithm used in the method of the present invention includes a special interference algorithm, and a genetic algorithm with integer and symbolic codes. Operators within the genetic algorithm include a selection operation, a crossover operation, and a mutation operation. The method of the present invention provides enormously improved design efficiencies and quality.

Other objectives, advantages, and novel features of the invention will become more apparent from the following detailed description when taken in conjunction with the accompanying drawings.

### BRIEF DESCRIPTION OF THE DRAWINGS

FIG. 1 is a flowchart of an intelligent 3D fixture design method according to the present invention.

FIG. 2 is cross-sectional view of fixing directions (S directions) for a fixture module.

FIG. 3 shows a cross-section of the workpiece being divided into P points.

FIG. 4 shows fixing points p2, pdn2 for the fixture module on the cross-section direction.

FIG. 5 shows the workpiece can be removed during the fixture module widely opened.

FIG. 6 shows no interference between the movement track of the fixture module and the workpiece.

FIG. 7 shows no interference between the fixture module and the other fixture module.

FIG. 8 shows no interference between a fixture module and an operating tool (a welding gun).

FIG. 9 shows an optimal fixture system and related specification and layout.

FIG. 10 shows an individual possessing 4×N genes with N groups consisted of 4 different gene types in a chromosome.

FIG. 11 shows costs associated with different types and specifications of fixture modules.

FIG. 12 shows fitness values of C(N).

FIG. 13 shows the initial population generated by Genetic Algorithm.

FIG. 14 shows the diagram of the selection probability for each individual.

FIG. 15 shows using a crossover operation to generate various offspring.

FIG. 16 shows a mutation operation and new generators.

FIG. 17 shows the lowest fitness value, which is also the lowest fixture systems cost.

FIG. 18 shows an optimal fixture system layout, with parameters sent back to a CAD system to automatically generate a 3D solid model.

FIG. 19 shows an example of 3D fixture.

FIG. 20 shows types of fixture module.

### DETAILED DESCRIPTION OF THE PREFERRED EMBODIMENT

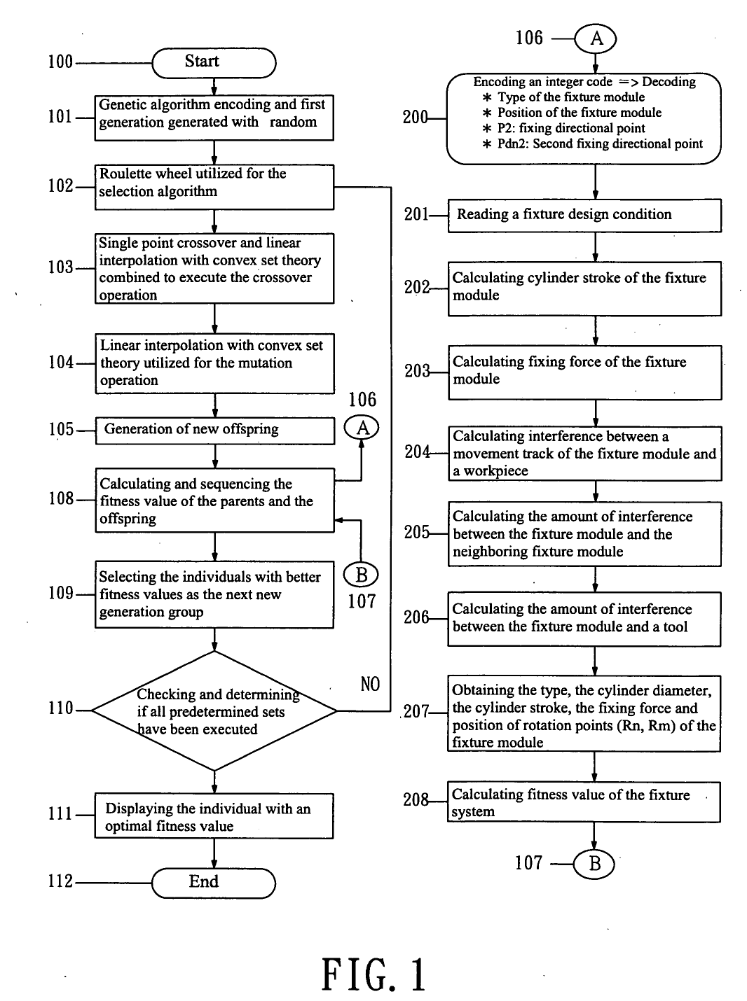

The intelligent 3D fixture design method of the present invention has a flow chart as shown in FIG. 1, which shows that, after a genetic coding operation, the first group is randomly generated; after a selection operation, a crossover operation, and a mutation operation, a new offspring is generated; after decoding the code and reading the associated fixture design conditions, a cylinder stroke of the fixture module is determined, as are a fixing force of the fixture module, movement tracking and workpiece interference amounts of the fixture module, interference amounts between the fixture module and its neighbor fixture module, and interference amounts between the fixture module and tools. The type, cylinder diameter, cylinder stroke, fixing force, and position of rotation points (Rn, Rm) of the fixture module are thereby obtained. Fitness values of the fixture system are determined; the fitness value order of the parent and the new offspring operated by the mutation operation is calculated, and individuals with better fitness values are selected to form a subsequent new group.

In these steps, the generation number is checked to determinate whether the predetermined generations have all been executed; if they have, an individual with the best fitness value is displayed, and the program terminated.

If the predetermined generation number is not finished, the program returns back to the selection operation, crossing operation, and mutation operation, to generate new offspring. The fitness value order of the parent and the new offspring operated by the mutation operation is calculated, and individuals with better fitness values are selected to form a subsequent new group until the predetermined generation number have finished.

### Special Interference Algorithm

The special interference algorithm makes use of two vectors \vec{T}₁ and \vec{T}₂ that are not located on the same side of a plane as a sufficient and necessary condition, as follows: sign(\vec{n}·\vec{T}₁−C)≠sign(\vec{n}·\vec{T}₂−C)

Where, \vec{n} is the plane normal vector; and

c is a constant for the plane.

It is assumed that the fixture module, fixture movement path, or tools are located in a space surrounded by six planes; wherein the six normal vector of the six planes are \vec{n}₁, \vec{n}₂ . . . \vec{n}₆, with six corresponding calculation constants c₁, c₂, . . . , c₆; each calculation constant is the sum of one vector \vec{T}₁ on the plane and its normal vector \vec{n} (C=\vec{n}·\vec{T}); \vec{T}₁ is a vector surrounded by the six planes, \vec{T}₂ is an interference calculating point vector; and a determination method is provided as follows:
1. When ∀i∈[1,2, . . . ,6], sign(\vec{n}ᵢ·\vec{T}₁−Cᵢ)=sign(\vec{n}ᵢ·\vec{T}₂−Cᵢ), \vec{T}₂ is in the space surrounded by six planes, then there is interference.
2. When ∃j∈[1,2, . . . ,6], sign(\vec{n}ᵢ·\vec{T}₂−Cᵢ)=0 and ∀i∈[1,2, . . . ,6], i≠j, sign(\vec{n}ᵢ·\vec{T}₁−Cᵢ)=sign(\vec{n}ᵢ·\vec{T}₂−Cᵢ), \vec{T}₂ is on the edge of the space and on the plane of the normal vector \vec{n}ⱼ, then there is no interference.
3. When ∃j,k∈[1,2, . . . ,6], j≠k, (\vec{n}ⱼ·\vec{T}₂−Cⱼ)=(\vec{n}ₖ·\vec{T}₂−Cₖ)=0 and ∀i∈[1,2, . . . ,6], i≠k, i≠k, sign(\vec{n}ᵢ·\vec{T}₁−Cᵢ)=sign(\vec{n}ᵢ·\vec{T}₂−Cᵢ), \vec{T}₂ is on the edge of the space and on a crossing line of two panels represented by the normal vectors \vec{n}ⱼ and \vec{n}ₖ, then there is no interference.
4. When ∃j,k,l∈[1,2, . . . 6], j≠k, k≠l, l≠j, (\vec{n}ⱼ·\vec{T}₂−Cⱼ)=(\vec{n}ₖ·\vec{T}₂−Cₖ)=(\vec{n}₁·\vec{T}₂−C₁)=0 and ∀i∈[1,2, . . . ,6], i≠j, i≠k, i≠l, sign(\vec{n}ᵢ·\vec{T}₁−Cᵢ)=sign(\vec{n}ᵢ·\vec{T}₂−Cᵢ), \vec{T}₂ is on the edge of the space and on a crossing point of three planes represented by normal vectors \vec{n}ⱼ, \vec{n}ₖ and \vec{n}ₗ, then there is no interference.
5. When the conditions are beyond the abovementioned four conditions, \vec{T}₂ is located out of the space surrounded by six planes, and there is no interference.

### Genetic Algorithm

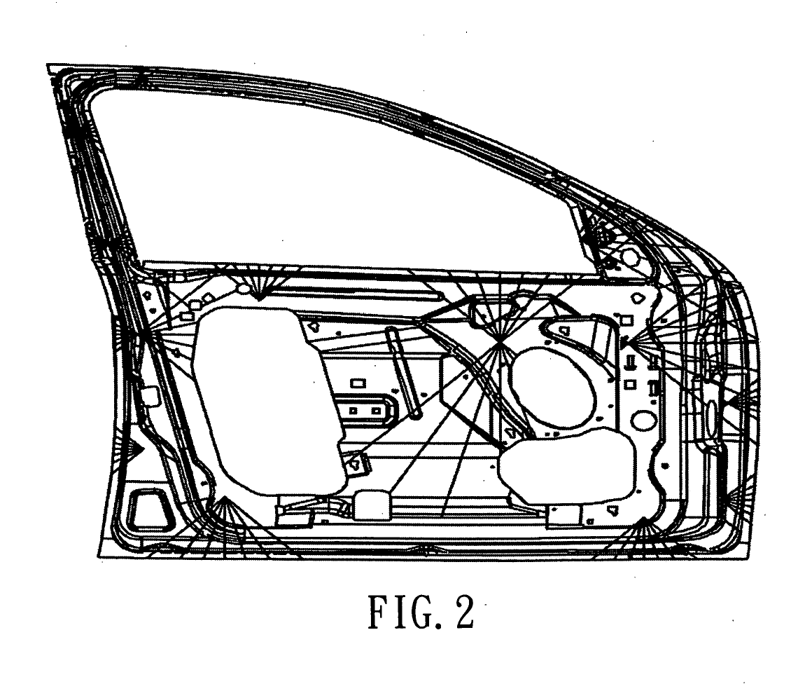

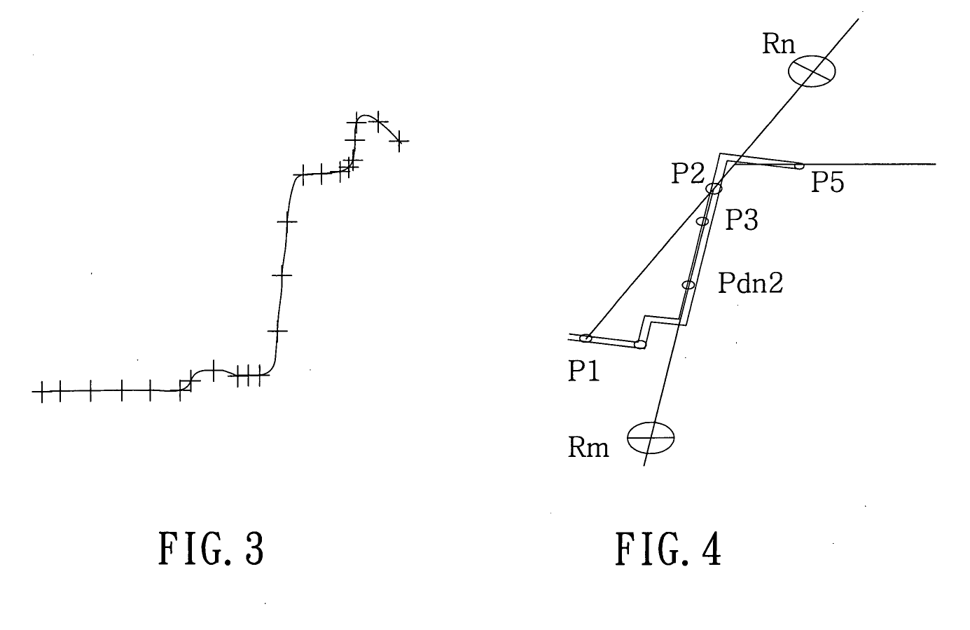

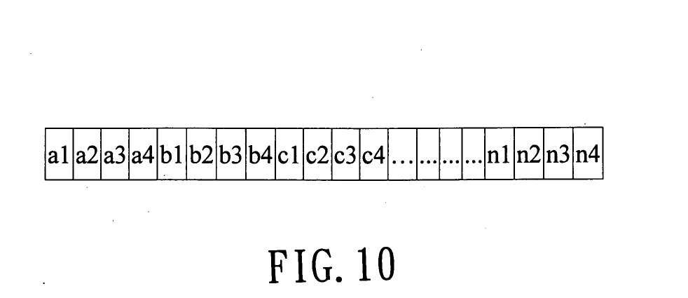

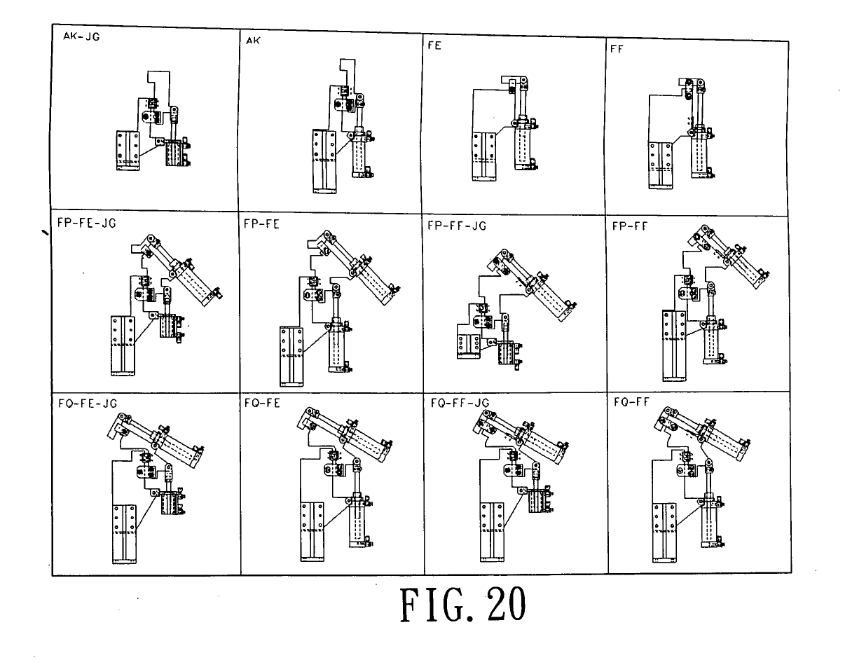

The genetic algorithm considers every individual of a gene as a parameter and determines the individual of a gene via coding. Assuming the fixture system includes N fixture modules, and the fixture module has T types, the workpiece with its fixing points can be cut into S cross-sections according to fixing directions for the fixture module, and P points are set from the fixing point to the edge of workpiece on every cross-section as positions for fixture module design parameters p2, pdn2. According to the above-mentioned problem, the fixture system in total has N fixture modules; every fixture module needs to select a type for the fixture module (T types), a fixing direction (S cross-sections ) and individual position for the parameter p2 and pdn2 (P points). Therefore, each fixture module has four parameters, and the entire fixture system has 4×N parameters. In the other words, this individual includes 4×N genes, and its genes are shown in FIG. 10.
(1) a₁, b₁, . . . , n₁ present fixture module types, which are shown by 0˜T integers in FIG. 20.
(2) a₂, b₂, . . . , n₂ present fixing directions, which are shown by 0˜S integers in FIG. 2.
(3) a₃, b₃, . . . , n₃ present positions of the fixture module design parameter p2, which are shown by 1˜P integers in FIG. 3 and FIG. 4.
(4) a₄, b₄, . . . , n₄ present positions of the fixture module design parameter pdn2, which are shown by 1˜P integers in FIG. 3 and FIG. 4.

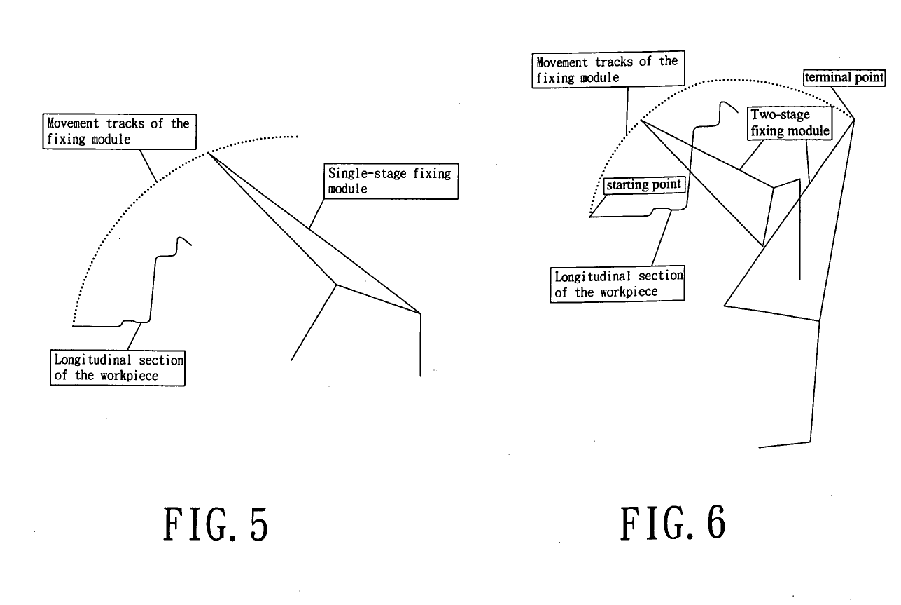

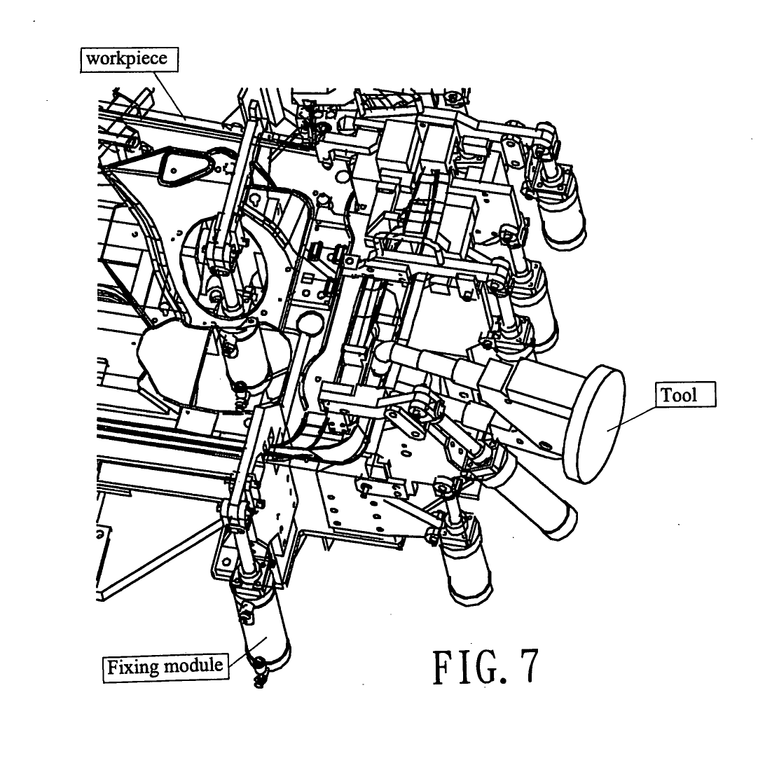

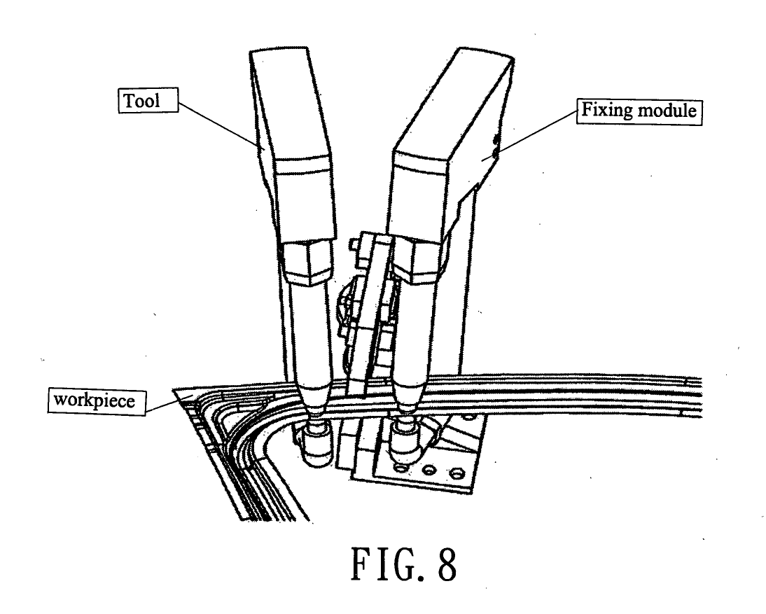

The limitation condition may be provided as ψ=(ψ₁, ψ₂, ψ₃, ψ₄, ψ₅), which is explained as follows:
(1) ψ₁ represents the stroke of the fixture module for removing the workpiece, as shown in FIG. 5.
(2) ψ₂ represents a necessary condition of the fixing force of the fixture module, such as a fixing force ≧30 kg.
(3) ψ₃ represents no interference between fixture modules, as shown in FIG. 7.
(4) ψ₄ represents no interference between the fixture module and an operating tool, as shown in FIG. 8.
(5) ψ₅ represents no interference between movement of the fixture module with respect to the workpiece, as shown in FIG. 6.

### Fitness Value

1. The types of the fixture modules are T₁, T₂, T₃, T₄, T₅, . . . , T₁₂ from simple types to complicate types.
2. The cylinder strokes of the fixture module are 50, 75, 100, 125, and 150.
3. The cylinder diameters of the fixture module are 40, 50, and 63.

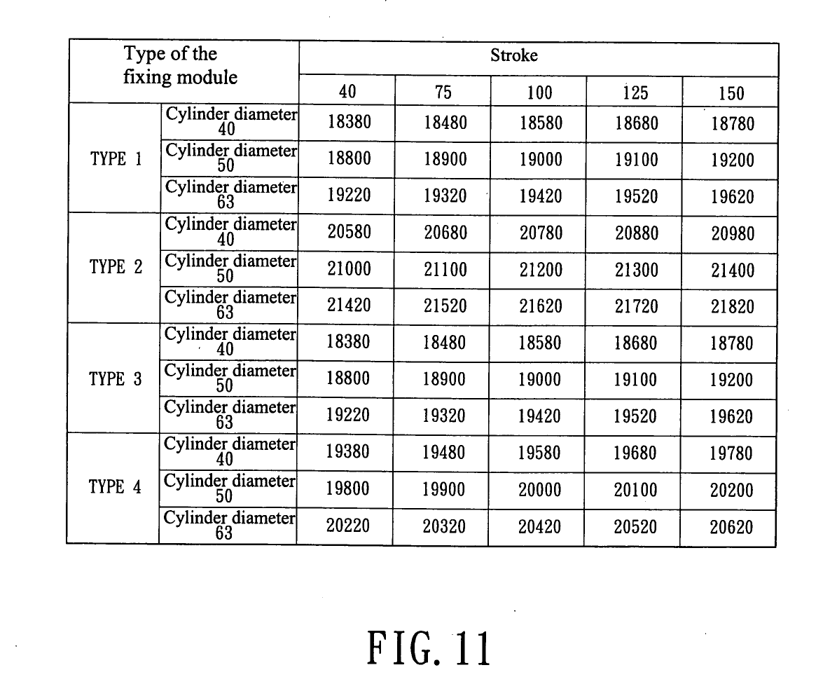

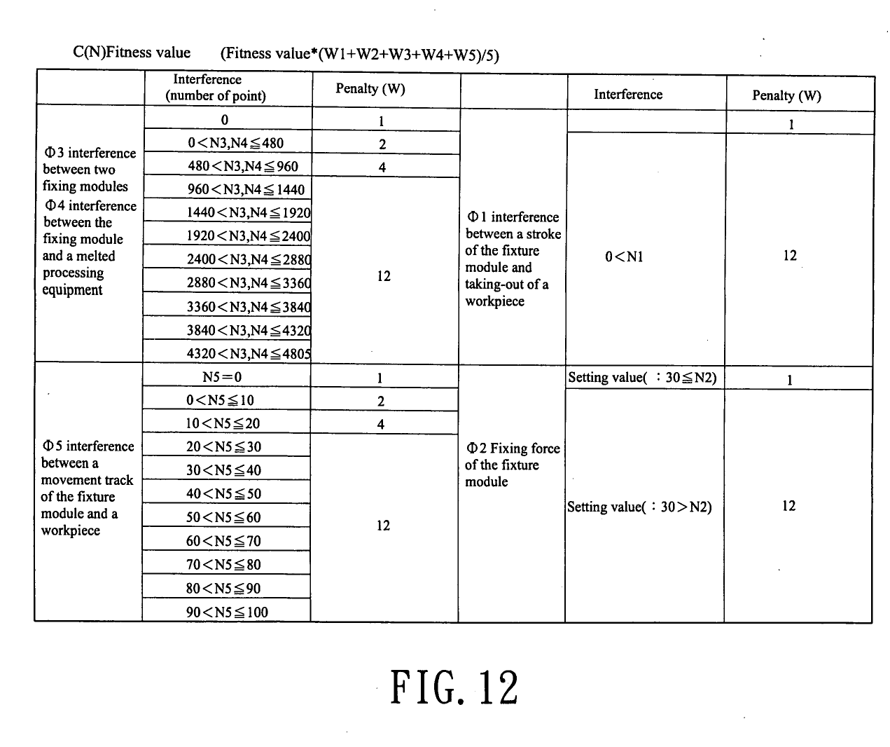

The evaluation index C(N) for fitness values takes the lowest total cost of all fixture modules as an optimal value according to the cost of the fixture module type and its cylinder stroke and cylinder diameter, as shown in FIG. 11, and an fitness value can be obtained as shown in FIG. 12.

### Generation and Coding of Initial Groups

The present invention utilizes integer and symbolic coding to indicate every gene value, and then generates chromosome and initial individual groups. The following steps show how to generate M initial individual groups, wherein one set of the vectors (x₁, x₂, . . . xᵢ, . . . , x_{N}) presents a set of N parameters that need to be determined.

### Algorithm Steps:

Step 1: randomly generating a random number β, wherein β belongs to [0, 1].

Step 2: make xᵢ=lᵢ+β(uᵢ−lᵢ), xᵢ is rounded to be integer, wherein lᵢ and uᵢ is in the range of xᵢ.

Step 3: repeating the above steps N times to generate one set of vectors (x₁, x₂, . . . , xᵢ, . . . , x_{N}).

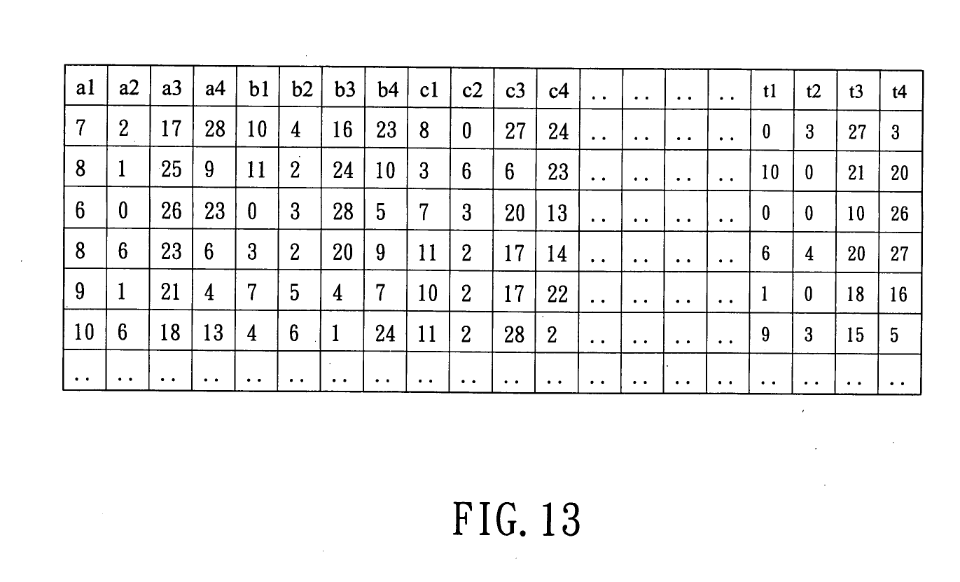

Step 4: repeating the above steps 1 to 3 M times to generate M initial groups; as shown in FIG. 13.

### Selection Method

Better parents are selected for a subsequent crossover operation, and a roulette wheel is utilized for the selection. The selection operation selects individuals with higher probabilities in the entire group.

For example: for individual k, its fitness value is fₖ, its probability in the entire group is pₖ, and

$${p}_{k} = {f}_{k} / {\sum }_{i = 1}^{M} {f}_{i} , \\ k = 1 , 2 , … , M . \qquad ( 1.1 )$$

Therefore, an accumulated probability qₖ of each set of chromosome in the entire group is:

$${q}_{k} = {\sum }_{i = 1}^{k} {p}_{i} , \\ k = 1 , 2 , … , M \qquad ( 1.2 )$$

where, M is the number of individuals in the group.

During the selection operation, the roulette wheel is turned M×Pₑ times, where Pₑ is a selection rate, and a member from the parent is selected to become a new member of the group according to each obtained probability. The following steps show how to generate M×Pₑ new group members.

### Generation Step:

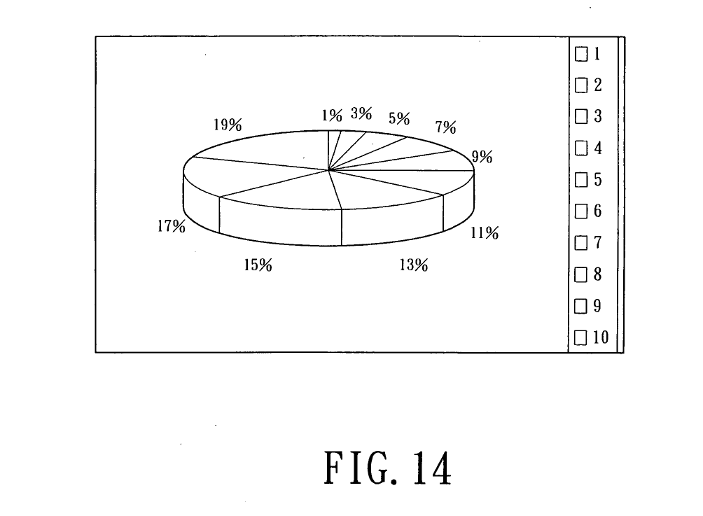

Step 1: randomly generating a random number r from [0, 1].
Step 2: if r≦q₁, a first individual is selected, if qₖ₋₁<r≦qₖ, the kth (2≦k≦M) individual is selected.
Step 3: repeating the above steps M×Pₑ times to select M×Pₑ new group members, as shown in FIG. 14.

### Generating Various Daughters Via the Crossover Method

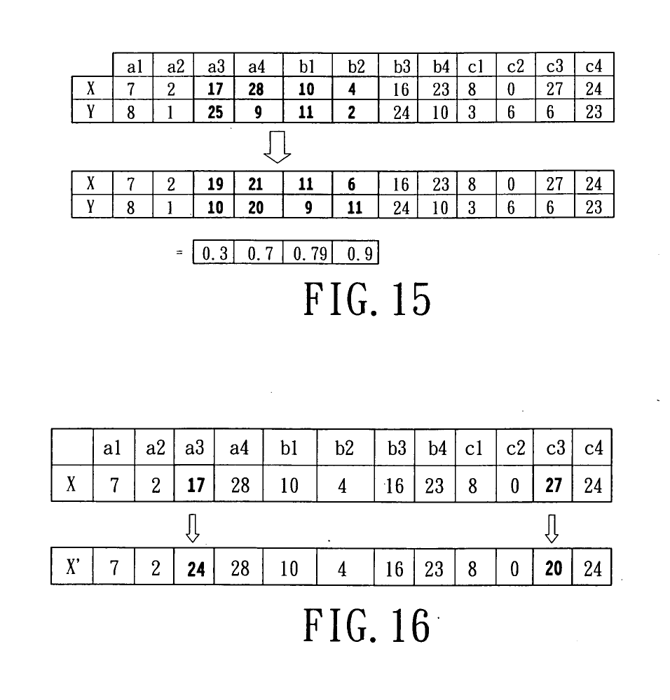

The crossover operation combines single point crossover and linear interpolation with convex set theory to randomly select four crossover points, exchanges the upper and lower two parents on the crossover point, uses linear interpolation to simultaneously calculate two gene values on the crossover points, and then generates two new offspring. For example, two different parents are x=(x₁, x₂, . . . , x_{N}) and y=(y₁, y₂, . . . , y_{N}); assuming point k is a randomly selected crossover point, the crossover method and the new daughters x′ and y′ are shown in FIG. 15.

x′=(x₁, x₂, . . . , x′ₖ, yₖ₊₂, . . . , y_{N}),

y′=(y₁, y₂, . . . , y′ₖ, xₖ₊₂, . . . , x_{N}), (1.3)

where, x′ₖ=xₖ+β(yₖ−xₖ), y′ₖ=lₖ+β(uₖ−lₖ), lₖ and uₖ is the range of yₖ, and β is a random number belonging to [0, 1]. Furthermore, x′ and y′ are rounded to be integers. This mixing crossover method and the new xₖ′ and yₖ′ generation method can generate various offspring and avoid premature.

### Mutation Method

The mutation operation uses linear interpolation with convex set theory as a basic concept, which randomly selects two points from the same group in one chromosome and performs linear interpolation to complete the mutation. This mutation method may also be viewed as performing a fine tuning in the space.

For example: the parent is x=(x₁, x₂, . . . , xᵢ, xⱼ, xₖ, . . . , x_{N}); xᵢ and xₖ are randomly selected for mutation; wherein, xᵢ and xₖ need to be in the same range, or otherwise need to be normalized. The mutation method and new daughter x′ are explained in the following:

x=(x₁, x₂, . . . , xₖ′, xⱼ, xᵢ′, . . . , x_{N}) (1.4)

where, x′₁=(1−β)x₁+βxₖ, x′ₖ=βxᵢ+(1−β)xₖ, and β is a random number belonging to [0,1], and xᵢ′, xₖ′ are rounded to be integers, as shown in FIG. 16.

Please refer to FIG. 1. FIG. 1 is a flowchart of an intelligent 3D fixture design method according to the present invention.

In step 101, after the genetic algorithm coding, the first generation group is randomly generated, as follows: the selection operation in step 102, the crossover algorithm in step 103, the mutation operation in step 104, generation of new offspring in step 105, connecting point A in steps 106 to step 200 to decode the integer code, reading fixture system design conditions in step 201, calculating cylinder stroke of the fixture module in step 202, calculating fixing force of the fixture module in step 203, calculating the interference between the movement track of the fixture module and the workpiece in step 204, calculating the amount of interference between the fixture module and its neighboring fixture module in step 205, calculating the amount of interference between the fixture module and the tools in step 206; obtaining the type, the cylinder diameter, the cylinder stroke and the fixing force of the fixture module in step 207; calculating fitness value of the fixture system in step 208; connecting point B in step 107 to step 108 for calculating and sequencing the fitness values of the parents and the offspring after the mutation algorithm, and selecting the individuals with better fitness values as the next new generation group in step 109.

In step 110, all predetermined sets are checked to determine if they have been executed; if all have been executed, step 111 is performed to display the individual with an optimal fitness value, and then step 112 is performed to end the process.

If not all of the predetermined generations have been executed, the process goes back to the selection operation in step 102, the crossover operation in step 103, the mutation operation in step 104, the generation of new offspring in step 105, step 106, . . . , step 109 until all of the predetermined generations have been executed.

The following description shows how an embodiment of the present invention may be utilized for car door panel welding fixture system optimized design.

The car door panel fixture system has 12 fixture modules. Each fixture module has its fixing point which had 7 cross-section directions; each cross-section is divided into 30 points from the clamping point to the edge of the car door panel, to be the position points of the fixture module design parameter p2 and pdn2. Therefore, the car doorpanel welding fixture system has 12 fixture modules, with each fixture module having 4 parameters, so that the entire fixture module has 48 parameters. There are 12 types of fixture modules, 7 fixing cross-section directions and 30 position points for the fixture module design parameters p2 and pdn2; therefore, the range of the entire fixture module selection space is about (12×7×30×30)¹².

The intelligent 3D fixture design method may be used to find an optimal 3D fixture module and related specification and layout as follows:

GA Algorithm Settings

Parents: 100, offspring: 80 generations: 400 selection rate: 0.8 mutation rate: 0.2

Genetic Code:

0 3 11 24 0 0 26 9 0 3 18 15 0 3 4 16 0 5 10
5 0 2 20 11 0 3 27 7 0 3 8 10 0 3 15 10 4 3
23 16 0 3 4 10 1 3 14 13

Total fitness value: 238400

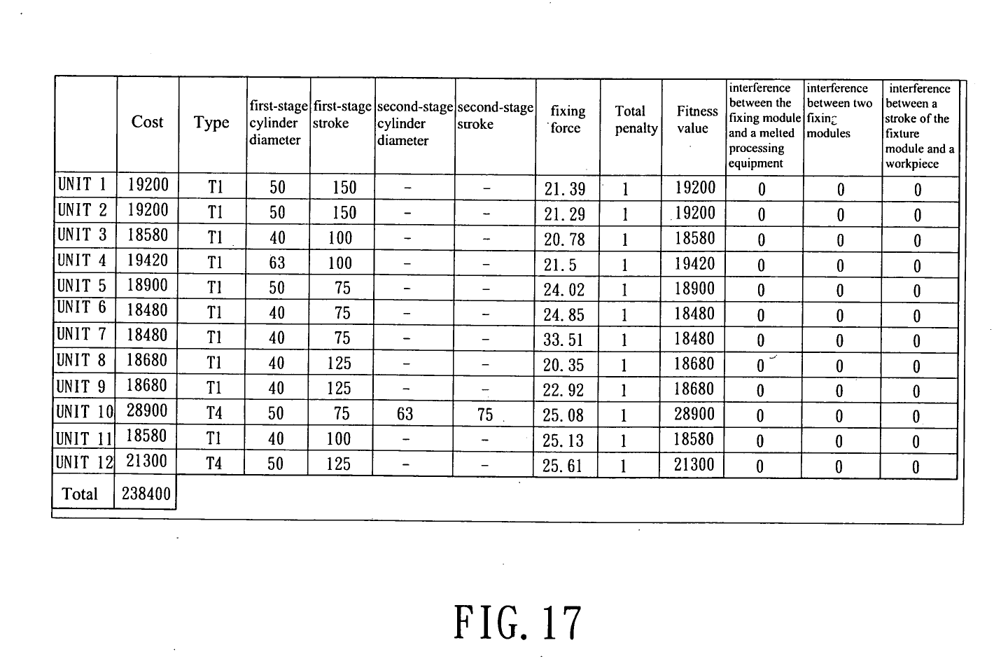

The total fitness value is the lowest fixture system cost, which is 238400, as shown in FIG. 17.

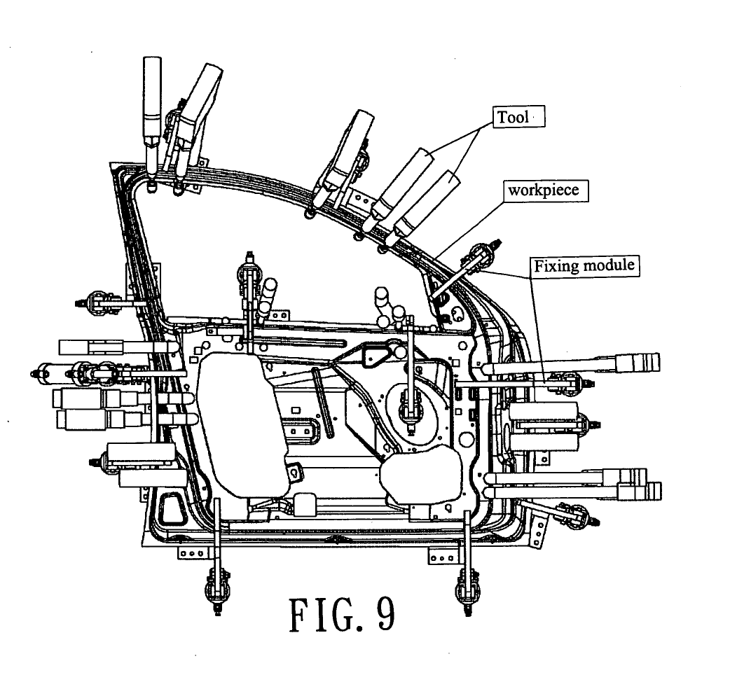

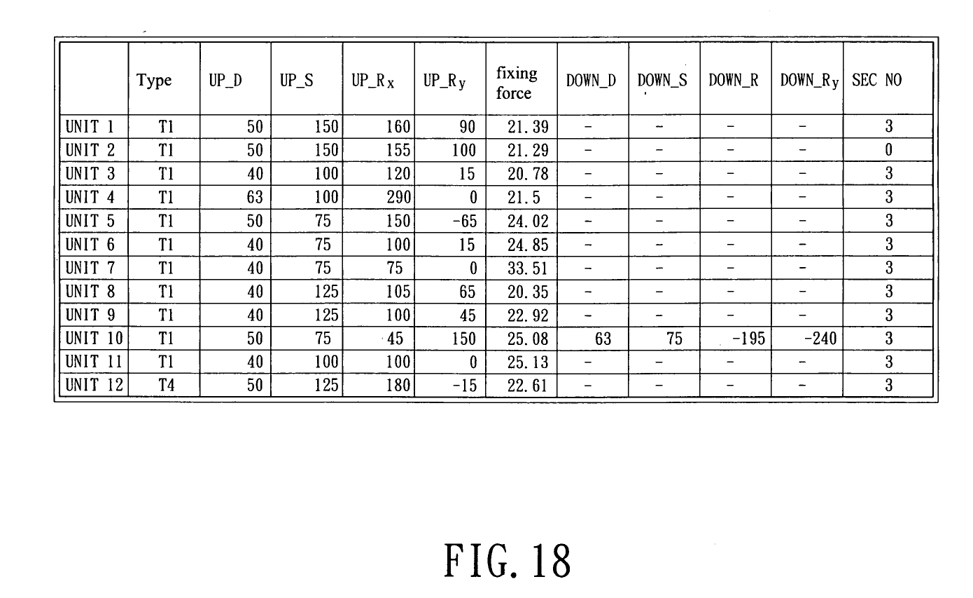

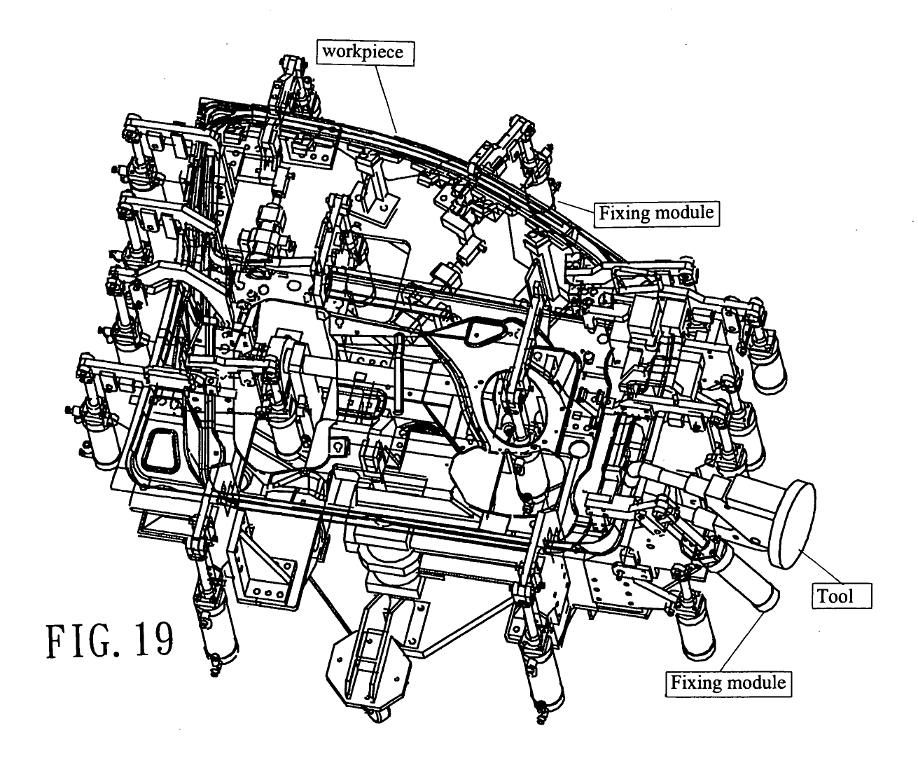

The type of the fixture module and its specifications and position parameters (as shown in FIG. 18) are sent back to the CAD program to automatically generate a 3D solid model (as shown in FIG. 9).

Result Comparisons:

| | prior design | current design |
|---|---|---|
| design hours (Hrs) | 112 | 64 |
| manufacturing cost (dollars) | 275100 | 238400 |

Although the present invention has been explained in relation to its preferred embodiment, it is to be understood that many other possible modifications and variations can be made without departing from the spirit and scope of the invention as hereinafter claimed.

What is claimed is:

1. An intelligent 3D fixture design method based on a parametric solid model of 3D CAD software, which utilizes a space vector to determine if interference exists, the interference position being between solid models of workpiece, tool and fixture module, and further utilizes a genetic algorithm to search type and related design shape and position variables of each fixture modules to design the optimal fixture system and related specification and layout.

2. The method as claimed in claim 1, wherein the method combines benefits of a 3D CAD software, space inference algorithm and a genetic algorithm to achieve a 3D parametric solid model for optimization purposes; the algorithm used in the method of the present invention including a space interference algorithm and a genetic algorithm with integer and symbolic codes.

3. The method as claimed in claim 2, wherein operators within the genetic algorithm include a selection algorithm, a crossing algorithm, and a mutation algorithm.

4. The method as claimed in claim 1, wherein the space interference algorithm makes use of two vectors \vec{T}₁ and \vec{T}₂ that are not located on the same side of a plane as a sufficient and necessary condition, as follows: sign(\vec{n}·\vec{T}₁−C)≠sign(\vec{n}·\vec{T}₂−C)
wherein: \vec{n} is the plane normal vector; and
c is a constant for the plane
assuming that the fixture module, fixture movement path, or tools are located in a space surrounded by six planes; wherein the six normal vector of the six planes are \vec{n}₁, \vec{n}₂ . . . \vec{n}₆, with six corresponding calculation constants c₁, c₂ . . . c₆, each calculation constant being the sum of one vector \vec{T}₁ on the plane and its normal vector \vec{n} (C=\vec{n}·\vec{T}), \vec{T}₁ being a vector surrounded by the six planes, \vec{T}₂ being an interference calculation point vector, a determination method provided as follows:
(1) when ∀i∈[1,2, . . . ,6],sign(\vec{n}ᵢ·\vec{T}₁−Cᵢ)=sign(\vec{n}ᵢ·\vec{T}₂−Cᵢ), \vec{T}₂ is in the space surrounded by six planes, then there is interference;
(2) when ∃j∈[1,2, . . . ,6], (\vec{n}ⱼ·\vec{T}₂−Cᵢ)=0 and ∀i∈[1,2, . . . ,6], i≠j, sign(\vec{n}ᵢ·\vec{T}₁−Cᵢ)=sign(\vec{n}ᵢ·\vec{T}₂−Cᵢ), \vec{T}₂ is on the edge of the space and on the plane of the normal vector \vec{n}ⱼ, then there is no interference;
(3) when ∃j,k∈[1,2, . . . ,6], j≠k, (\vec{n}ⱼ·\vec{T}₂−Cⱼ)=(\vec{n}ₖ·\vec{T}₂−Cₖ)=0 and ∀i∈[1,2, . . . ,6], i≠j, i≠k, sign(\vec{n}ᵢ·\vec{T}₁−Cᵢ)=sign(\vec{n}ᵢ·\vec{T}₂−Cᵢ), \vec{T}₂ is on the edge of the space and on a crossing line of two panels represented by the normal vectors \vec{n}ⱼ and \vec{n}ₖ, then there is no interference;
(4) when ∃j,k,l∈[1,2, . . . ,6], j≠k, k≠l, l≠j, (\vec{n}ⱼ·\vec{T}₂−Cⱼ)=(\vec{n}ₖ·\vec{T}₂−Cₖ)=(\vec{n}₁·\vec{T}₂−Cₗ)=0 and ∀i∈[1,2, . . . ,6], i≠j, i≠k, i≠l, sign(\vec{n}ᵢ·\vec{T}₁−Cᵢ)=sign(\vec{n}ᵢ·\vec{T}₂−Cᵢ), \vec{T}₂ is on the edge of the space and on a crossing point of three planes represented by normal vectors \vec{n}ⱼ, \vec{n}ₖ and \vec{n}ₗ, then there is no interference; and
(5) when the conditions are not covered by the abovementioned four conditions, \vec{T}₂ is located out of the space surrounded by the six planes and there is interference.

5. An intelligent 3D fixture design method based on a parametric solid model of 3D CAD software, which uses a space vector to determine existence of interference, the interference position being between solid models of—workpiece, tooland fixture module.

6. The method as claimed in claim 5, wherein the space interference algorithm makes use of two vectors \vec{T}₁ and \vec{T}₂ as a sufficient and necessary condition that are not located on the same side of a plane as follows: sign(\vec{n}·\vec{T}₁−C)≠sign(\vec{n}·\vec{T}₂−C)
wherein \vec{n} is the plane normal vector; and
c is a constant for the plane;
wherein it is further assumed that the fixture module, fixture movement path, or tool is located in a space surrounded by the six planes, the six normal vector of the six planes being \vec{n}₁, \vec{n}₂ . . . \vec{n}₆ with six corresponding calculation constants c₁, c₂, . . . , c₆, each calculation constant being the sum of one vector \vec{T}₁ on the plane and its normal vector \vec{n}(C=\vec{n}·\vec{T}), \vec{T}₁ being a vector surrounded by the six planes, \vec{T}₂ being an interference calculating point vector, and a determination method is provided as follows:
(1) ∀i∈[1,2, . . . ,6], sign(\vec{n}ᵢ·\vec{T}₁−Cᵢ)=sign(\vec{n}ᵢ·\vec{T}₂−Cᵢ), \vec{T}₂ is in the space surrounded by six planes, then there is interference;
(2) when ∃j∈[1,2, . . . ,6], (\vec{n}ⱼ·\vec{T}₂−Cᵢ)=0 and ∀i∈[1,2, . . . ,6], i≠j, sign(\vec{n}ᵢ·\vec{T}₁−Cᵢ)=sign(\vec{n}ᵢ·\vec{T}₂−Cᵢ), \vec{T}₂ is on the edge of the space or on the plane of the normal vector \vec{n}ⱼ then there is no interference;
(3) when ∃j,k∈[1,2, . . . ,6], j≠k, (\vec{n}ⱼ·\vec{T}₂−Cⱼ)=(\vec{n}ₖ·\vec{T}₂−Cₖ)=0 and ∀i∈[1,2, . . . ,6], i≠j, i≠k, sign(\vec{n}ᵢ·\vec{T}₁−Cᵢ)=sign(\vec{n}ᵢ·\vec{T}₂−Cᵢ), \vec{T}₂ is on the edge of the space or on a crossing line of two panels represented by the normal vectors \vec{n}ⱼ and \vec{n}ₖ, then there is no interference;
(4) when ∃j,k,l∈[1,2, . . . ,6]j≠k, k≠l, l≠j, (\vec{n}ⱼ·\vec{T}₂−Cⱼ)=(\vec{n}ₖ·\vec{T}₂−Cₖ)=(\vec{n}₁·\vec{T}₂−Cₗ)=0 and ∀i∈[1,2, . . . ,6], i≠j, i≠k, i≠l, sign(\vec{n}ᵢ·\vec{T}₁−Cᵢ)=sign(\vec{n}ᵢ·\vec{T}₂−Cᵢ), \vec{T}₂ is on the edge of the space or on a crossing point of three planes represented by normal vectors \vec{n}ⱼ, \vec{n}ₖ and \vec{n}ₗ, then there is no interference; and
(5) when conditions are not within the abovementioned four conditions, then \vec{T}₂ is located outside of the space surrounded by the six planes and there is interference.

7. An intelligent 3D fixture design method based on a parametric solid model of 3D CAD software, which utilizes a genetic algorithm to search type and related design shape and position parameters of each fixture module to design an optimal fixture system with a related specification and layout.

8. The method as claimed in claim 7, wherein operators within the genetic algorithm include a selection operation, a crossover operation, and a mutation operation.

9. The method as claimed in claim 1, wherein the method integrates optimized benefits of the genetic algorithm and has following characteristics:
in a step 101, after genetic algorithm coding, a first generation group is randomly generated as follows: a selection operation in step 102, a crossover operation in step 103, a mutation operation in step 104, a generation of new offspring step 105, a step for connecting a point A in a step 106 to a step 200 to decode an integer code, a step 201 for reading a fixture design condition, a step 202 for calculating cylinder stroke of the fixture module, a step 203 for calculating fixing force of the fixture module, a step 204 for calculating interference between a movement track of the fixture module and a workpiece, a step 205 for calculating the amount of interference between the fixture module and the neighboring fixture module, a step 206 for calculating the amount of interference between the fixture module and a tool; a step 207 for obtaining the type, the cylinder diameter, the cylinder stroke, and the fixing force of the fixture module; a step 208 for calculating the fitness value of the fixture system; a step 109 for connecting a point B in a step 107 to a step 108 for calculating and sequencing the fitness values of the parents and the daughters after the mutation operation, and selecting the individuals with better fitness values as the next new generation group;
wherein in a step 110 all predetermined generations are checked to determine if they have been executed, and if all have been executed a step 111 is performed to display the individual with an optimal fitness value, and then step 112 is performed to end the process; and
wherein if not all of the predetermined generations have been executed, the process goes back to the selection operation in step 102, the crossover operation in step 103, the mutation operation in step 104, the generation of new offspring in step 105, step 106, . . . , step 109 until all of the predetermined generations have been executed.

10. The method as claimed in claim 1, wherein the method integrates optimized benefits of the genetic algorithm and has following characteristics:
in a step 101, after genetic algorithm coding, a first generation group is randomly generated as follows: a selection algorithm in step 102, a crossover operation in step 103, a mutation operation in step 104, a generation of new offspring step 105, a step for connecting a point A in a step 106 to a step 200 to decode an integer code, a step 201 for reading a fixture design condition, a step 202 for calculating cylinder stroke of the fixture module, a step 203 for calculating fixing force of the fixture module, a step 204 for calculating interference between a movement track of the fixture module and a workpiece, a step 205 for calculating the amount of interference between the fixture module and the neighboring fixture module, a step 206 for calculating the amount of interference between the fixture module and a tool; a step 207 for obtaining the type, the cylinder diameter, the cylinder stroke, and the fixing force of the fixture module; a step 208 for calculating the fitness value of the fixture system; a step 109 for connecting a point B in a step 107 to a step 108 for calculating and sequencing the fitness values of the parents and the offspring after the mutation algorithm, and selecting the individuals with better fitness values as the next new generation group;
wherein in a step 110 all predetermined sets are checked to determine if they have been executed, and if all have been executed a step 111 is performed to display the individual with an optimal fitness value, and then step 112 is performed to end the process; and
wherein if not all of the predetermined sets have been executed, the process goes back to the selection algorithm in step 102, the crossover operation in step 103, the mutation operation in step 104, the generation of new offspring in step 105, step 106, . . . step 109 until all of the predetermined generations have been executed.
